(19) United States
(12) Patent Application Publication
(10) Pub. No.: US 2026/0243695 A1
(43) Pub. Date: Aug. 20, 2026

(54) Defect Inspecting Device, and Defect Inspecting Method

(71) Applicants: Hitachi High-Tech Corporation, Minato-ku, Tokyo (JP); Nikon Corporation, Minato-ku, Tokyo (JP)

(72) Inventors: Eiji ARIMA, Tokyo (JP); Toshifumi HONDA, Tokyo (JP); Yuta URANO, Tokyo (JP); Hiromichi YAMAKAWA, Tokyo (JP); Shunichi MATSUMOTO, Tokyo (JP); Jin NISHIKAWA, Tokyo (JP); Takashi TOMOZAWA, Tokyo (JP); Takahiro MASADA, Tokyo (JP)

(21) Appl. No.: 19/161,795

(22) PCT Filed: Jun. 16, 2023
(86) PCT No.: PCT/JP2023/022383

§ 371 Date: Sep. 3, 2025

(51) Int. Cl. G01N 21/88; G01B 11/06; G01N 21/47; G01N 21/95

(52) U.S. Cl. CPC G01N 21/8806; G01B 11/0608; G01N 21/4738; G01N 21/8851; G01N 21/9501; G01N 2201/121

(57) ABSTRACT

To provide a defect inspecting device and a defect inspecting method capable of performing the detection with high sensitivity by reducing an influence on a change in height of a sample surface. To achieve the above-mentioned object, a defect inspecting device includes: an illumination unit configured to irradiate a sample with light emitted from a light source; a detection unit configured to detect scattered light generated from the sample; a sample height detection unit configured to measure a variation amount of the sample in a direction perpendicular to a surface of the sample; a photoelectric conversion unit that converts the scattered light detected by the detection unit into an electric signal; and a signal processing unit configured to detect a defect of the sample by processing the electric signal converted by the photoelectric conversion unit, wherein the detection unit includes a mechanism that adjusts a position after an aperture is branched corresponding to the variation amount of the surface of the sample acquired by the sample height detection unit, and a mechanism that detects scattered light generated from the sample by branching the aperture at a plurality of detection elevation angles in a separated manner, and the signal processing unit includes a mechanism that corrects positions of a plurality of images formed by branching the aperture corresponding to the variation amount of the surface of the sample acquired by the sample height detection unit.

### TECHNICAL FIELD

The present invention relates to a defect inspecting device, and a defect inspecting method.

### BACKGROUND ART

On a manufacture line of a semiconductor board, thin film board or the like, to maintain and enhance a yield of products, an inspection of defects existing on a surface of a semiconductor board, a thin film board or the like has been performed.

As a background art in this technical field, there has been known a technique disclosed in PTL 1, for example. In PTL 1, the description is made with respect to the configuration “configured to perform the division of a full focusing NA of the focusing sub system into different segments, and to perform the orientation of scattered light focused in the different segments toward another detector”. As an embodiment, with respect to an aperture mirror disposed on a Fourier plane of the focusing sub system, there is the description “while allowing scattered light focused in one segment of the focusing NA pass through an aperture mirror, the aperture mirror reflects scattered light focused in another segment of the focusing NA”. Further, there is disclosed a technique that is “configured to separate scattered light in one of different segments based on polarization, and forms a different portion of the scattered light”, and suppresses surface scattering from a wafer surface.

### CITATION LIST

### Patent Literature

PTL 1: JP 2014-504370 A

### SUMMARY OF INVENTION

### Technical Problem

A defect inspection used in a manufacturing steps of semiconductors or the like is required to satisfy conditions such as: (1) detection of a minute defect, (2) measurement of a size of a detected defect with high accuracy, (3) inspection of a sample in a nondestructive manner, for example, without degrading the sample, (4) when inspection is made with respect to identical samples, for example, a substantially fixed inspection result is obtained with respect to the number, the positions, the sizes, kinds of defects of the detected defects, and (5) inspection of a large number of samples within a fixed time.

In the technique disclosed in PTL 1, to realize the inspection also with respect to a minute defect of 20 nm or less, the discrimination between scattered light and background scattered light is performed such that an optical path is branched using “an aperture mirror” provided to a Fourier surface of an objective lens, and the optical paths are branched using polarization for every branched optical path.

The inspecting method that branches the optical paths is largely influenced by a change in height of a sample surface generated during the inspection. The sample is rotated at a high speed amounting to several thousands RPM (rotation per minute) during inspection and hence, a change in height is generated with respect to a direction perpendicular to a sample surface due to warping or chuck of a sample, influence of an air flow, and the displacement of a rotational axis. When this change in height occurs at a highest speed, a change in height is generated at the same frequency as the rotation of the sample. Due to this change in height, defocusing on a sample surface with respect to an inspection system occurs and hence, the resolution of an image on the sensor surface is lowered. As a result, an image is not converged into a pixel and hence, a signal that the pixel outputs is lowered. Further, the position at which an image is formed on the sensor differs for every branched optical path. Accordingly, scattered light is detected from the same region and hence, the correspondence relationship between the pixels on the sensor for respective branched optical paths is collapsed. As a result, a drawback arises that the addition of sensor pixels for every branched optical path cannot be performed.

### Solution to Problem

According to the present invention, for example, there is provided a defect inspecting device that includes: an illumination unit configured to irradiate a sample with light emitted from a light source; a detection unit configured to detect scattered light generated from the sample; a sample height detection unit configured to measure a variation amount of the sample in a direction perpendicular to a surface of the sample; a photoelectric conversion unit that converts the scattered light detected by the detection unit into an electric signal; and a signal processing unit configured to detect a defect of the sample by processing the electric signal converted by the photoelectric conversion unit, wherein the detection unit includes a mechanism that adjusts a position after an aperture is branched corresponding to the variation amount of the surface of the sample acquired by the sample height detection unit, and a mechanism that detects scattered light generated from the sample by branching the aperture at a plurality of detection elevation angles in a separated manner, and the signal processing unit includes a mechanism that corrects positions of a plurality of images formed by branching the aperture corresponding to the variation amount of the surface of the sample acquired by the sample height detection unit.

### Advantageous Effects of Invention

According to the present invention, it is possible to provide a defect inspecting device and a defect inspecting method capable of performing the detection with high sensitivity by reducing an influence on a change in height of a sample surface.

### BRIEF DESCRIPTION OF DRAWINGS

FIG. 1 is an overall schematic configuration view of a defect inspecting device according to a first embodiment.

FIG. 2 is a view illustrating a first example of an illumination intensity distribution shape realized by an illumination unit according to the first embodiment.

FIG. 3 is a view illustrating a second example of an illumination intensity distribution shape realized by the illumination unit according to the first embodiment.

FIG. 4 is a view illustrating a third example of an illumination intensity distribution shape realized by the illumination unit according to the first embodiment.

FIG. 5 is a view illustrating a fourth example of an illumination intensity distribution shape realized by the illumination unit according to the first embodiment.

FIG. 6 is a view illustrating a fifth example of an illumination intensity distribution shape realized by the illumination unit according to the first embodiment.

FIG. 7 is a view illustrating an optical element included in an illumination intensity distribution control unit according to the first embodiment.

FIG. 8 is a view illustrating an illumination distribution shape and a scanning direction on a sample surface according to the first embodiment.

FIG. 9 is a view illustrating a trajectory of an illumination spot by scanning according to the first embodiment.

FIG. 10 is a side view of an arrangement and a detection direction of a detection unit according to the first embodiment.

FIG. 11 is a plan view of an arrangement and a detection direction of a detection unit according to the first embodiment.

FIG. 12 is a configuration view of a detection unit according to the first embodiment.

FIG. 13 is a view illustrating arrangement of an illumination spot and a photoelectric conversion unit according to the first embodiment.

FIG. 14 is a view of the arrangement in FIG. 13 as viewed from above the plane of FIGURE.

FIG. 15 is a schematic view of three-dimensional arrangement of a sample and a detection unit according to the first embodiment.

FIG. 16 is a view illustrating a cross section of a photoelectric conversion unit according to the first embodiment.

FIG. 17 is a graph illustrating the relationship between the absorption rate of an antireflection film of the photoelectric conversion unit and the incident angle according to the first embodiment.

FIG. 18 is a schematic configuration view of a sample height detection unit according to the first embodiment.

FIG. 19 is a configuration view of a detection unit according to the first embodiment, and is a view for explaining a height direction displacement of a sample surface, an imaging position displacement, and an imaging blur.

FIG. 20 is a view for explaining the imaging position displacement and an imaging blur at a high angle detection unit before the height displacement according to the first embodiment.

FIG. 21 is a graph for explaining the imaging position displacement and an imaging blur at the high angle detection unit after the height displacement according to the first embodiment.

FIG. 22 is a graph for explaining an imaging position displacement and an imaging blur at the low angle detection unit before the height displacement according to the first embodiment.

FIG. 23 is a graph for explaining the imaging position displacement and an imaging blur at the low angle detection unit after the height displacement according to the first embodiment.

FIG. 24 is a functional block diagram illustrating details of a signal processing unit according to the first embodiment.

FIG. 25 is a configuration view of a detection unit according to a second embodiment, and is a view for explaining details of displacement of a sample surface in a height direction and an optical element adjustment mechanism.

FIG. 26 is a functional block diagram of a signal processing unit according to the second embodiment.

FIG. 27 is a functional block diagram of another signal processing unit according to the second embodiment.

FIG. 28 is a graph illustrating a cross-correlation filter in a filter processing unit according to a third embodiment.

FIG. 29 is a graph illustrating a cross-correlation filter in a filter processing unit according to the third embodiment.

FIG. 30 is a functional block diagram of a signal processing unit according to the third embodiment.

FIG. 31 is a configuration view of a detection unit according to a fourth embodiment.

FIG. 32 is a functional block diagram of a signal processing unit according to a fifth embodiment.

FIG. 33 is a configuration view of a detection unit according to a sixth embodiment.

### DESCRIPTION OF EMBODIMENTS

Hereinafter, embodiments of the present invention will be described with reference to the drawings. In the embodiments, a defect inspecting device used in defect inspection performed in a manufacturing process of a semiconductor or the like will be described.

### First Embodiment

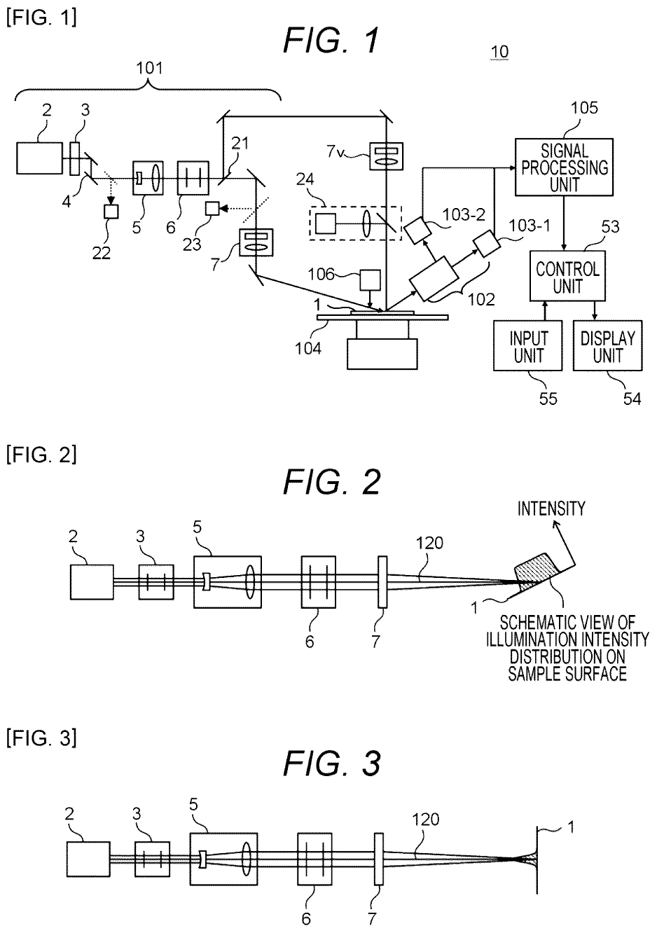

FIG. 1 is an overall schematic configuration view of a defect inspecting device according to this embodiment. In FIG. 1, the defect inspecting device 10 includes an illumination unit 101, a detection unit 102, photoelectric conversion units 103-1 and 103-2 (hereinafter, units 103-1, 103-2 being collectively referred to as a photoelectric conversion unit 103 in some cases), a stage 104 which is movable in a direction perpendicular to a plane by an actuator and on which a sample 1 can be placed, a signal processing unit 105, a sample height detection unit 106, a control unit 53, a display unit 54, and an input unit 55.

The illumination unit 101 appropriately includes a laser light source 2, an attenuator 3, an emitted light adjustment unit 4, a beam expander 5, a polarization control unit 6, and an illumination intensity distribution control unit 7. A laser light beam emitted from the laser light source 2 is adjusted to a desired beam intensity by the attenuator 3, is adjusted to a desired beam position and a beam traveling direction by the emitted light adjustment unit 4, is adjusted to a desired beam diameter by the beam expander 5, is adjusted to a desired polarization state by the polarization control unit 6, is adjusted to a desired intensity distribution by the illumination intensity distribution control unit 7, and is illuminated on an inspection target region of the sample 1.

An incident angle of an illumination light with respect to a sample surface is determined based on a position and an angle of a reflection mirror of an emitted light adjustment unit 4 arranged in an optical path of the illumination unit 101. The incident angle of the illumination light is set to an angle suitable for the detection of a minute defect. The larger an illumination incident angle, that is, the smaller an illumination elevation angle (an angle formed by the sample surface and an illumination optical axis), the weaker a scattered light (referred to as a haze) from minute unevenness of the sample surface, which becomes a noise with respect to a scattered light from minute foreign matters on the sample surface, and such setting of the incident angle of the illumination light is suitable for detecting minute defects. Accordingly, in a case where scattered light from the minute unevenness on the sample surface obstructs the detection of minute defects, the incident angle of the illumination light is preferably set to 75 degrees or more (the elevation angle being set to 15 degrees or less). On the other hand, in the obliquely incident illumination, the smaller an illumination incident angle, the larger an absolute amount of scattered light from minute foreign matters is increased. Accordingly, in a case where a shortage of an amount of scattered light from the defects obstructs the detection of minute defects, an incident angle of the illumination light is preferably set to 60 degrees or more and 75 degrees or less (the elevation angle being set to 15 degrees or more and 30 degrees or less). Further, in the case where the obliquely incident illumination is performed, by setting a polarized light of the illumination to a P-polarized light by performing a polarization control in a polarization control unit 6 of the illumination unit 101, a scattered light from defects on the sample surface is increased as compared with a case where other polarized lights are used. Further, in a case where the scattered light from the minute unevenness on the sample surface obstructs the detection of the minute defects, by forming the polarized light of the illumination into an S-polarized light, the scattered light from the minute unevenness on the sample surface is reduced as compared with other polarized lights.

In addition, as illustrated in FIG. 1, when necessary, by inserting a mirror 21 into an optical path of the illumination unit 101 and by arranging another mirror appropriately, the illumination optical path is changed so that illumination light is emitted from a direction substantially perpendicular to the sample surface (vertical illumination). At this time, the illumination intensity distribution on the sample surface is controlled by the illumination intensity distribution control unit 7v in the same manner as the obliquely incident illumination. In order to obtain scattered light from the obliquely incident illumination and concave defects (flaws at the time of polishing or crystal defects in a crystal material) on the sample surface by inserting a beam splitter at the same position as the mirror 21, the vertical illumination that is incident substantially perpendicular to the sample surface is suitable.

As the laser light source 2, in order to detect minute defects in the vicinity of the sample surface, a high-output laser light source that oscillates an ultraviolet laser beam or a vacuum ultraviolet laser beam of a short-wavelength (wavelength of 355 nm or less) and has an output of 2 W or more with a wavelength that hardly penetrates into the inside of a sample. A diameter of the emitted beam is about 1 mm. In order to detect defects inside the sample, as a wavelength that easily penetrates into the inside of the sample, a light source that oscillates a visible or infrared laser having a wavelength is used.

The attenuator 3 appropriately includes: a first polarizing plate, a ½ wavelength plate rotatable around an optical axis of the illumination light, and a second polarizing plate. The light incident on the attenuator 3 is converted into a linearly polarized light by a first polarizing plate, then, the polarization direction of the linearly polarized light is rotated in an arbitrary direction in accordance with a slow axis azimuth angle of a ½ wavelength plate, and the light passes through a second polarizing plate. By controlling the azimuth angle of the ½ wavelength plate, the light intensity is reduced at an arbitrary ratio. When the linear polarization degree of the light that is incident on the attenuator 3 is sufficiently high, the first polarizing plate is not necessarily required. As the attenuator 3, an attenuator is used where in the relationship between an input signal and a light reduction ratio is calibrated in advance. As the attenuator 3, an ND filter having a gradation density distribution, or ND filters having a plurality of different densities respectively can be used in a switchable manner.

The emitted light adjustment unit 4 includes a plurality of reflection mirrors. In this embodiment, the description is made with respect to an example where the emitted light adjustment unit 4 is constituted of two reflection mirrors. However, the emitted light adjustment unit 4 may be appropriately constituted of three or more reflection mirrors. In this embodiment, a three-dimensional orthogonal coordinate system (XYZ coordinates) is provisionally defined, and it is assumed that an incident light incident on the reflection mirrors travels in the +X direction. The first reflection mirror is installed so as to deflect an incident light in the +Y direction (incidence and reflection in the XY plane), and the second reflection mirror is installed so as to deflect a light reflected by the first reflection mirror in the +Z direction (incidence and reflection in the YZ plane). With respect to the respective reflection mirrors, the position and the traveling direction (angle) of a light emitted from the emitted light adjustment unit 4 are adjusted by a parallel movement and a tilt angle adjustment of each reflection mirror. As described above, by adopting the arrangement where the incident/reflection surface (XY plane) of the first reflection mirror and the incident/reflection surface (YZ plane) of the second reflection mirror are orthogonal to each other, the positioning and the angle adjustment of a light emitted from the emitted light adjustment unit 4 (traveling in the +Z direction) on the XZ plane and the positioning and the angle adjustment of a light emitted from the emitted light adjustment unit 4 on the YZ plane can be performed independently.

The beam expander 5 has two or more lens groups, and has a function of expanding a diameter of an incident parallel luminous flux. For example, as the beam expander 5, a Galileo-type beam expander that includes a combination of a concave lens and a convex lens is used. The beam expander 5 is installed on a translation stage having two or more axes, and the position of the beam expander 5 can be adjusted such that a predetermined beam position and the center of the beam expander 5 are aligned with each other. Further, the image processing device 1 has a tilt angle adjustment function of the entire beam expander 5 so that an optical axis of the beam expander 5 is aligned with a predetermined beam optical axis. By adjusting a distance between lenses, it is possible to control a magnification ratio of a diameter of a luminous flux (zoom mechanism). When a light that is incident on the beam expander 5 is not parallel, the enlargement of the diameter of the luminous flux and the collimation (the quasi-collimation of the luminous flux) are simultaneously performed by adjusting the distance between the lenses. The collimation of the luminous flux may be performed by arranging a collimating lens independently from the beam expander 5 upstream of the beam expander 5. The magnification of a beam diameter by the beam expander 5 is about 5 times to 10 times and hence, and the beam having a beam diameter of 1 mm emitted from the light source is enlarged to have the diameter of about 5 mm to 10 mm.

The polarization control unit 6 is constituted of a ½ wavelength plate and a ¼ wavelength plate, and controls a polarization state of an illumination light to an arbitrary polarization state. In the middle of an optical path of the illumination unit 101, a beam monitor 22 measures the state of a light incident on the beam expander 5, and the state of a light incident on an illumination intensity distribution control unit 7.

FIG. 2 to FIG. 6 are schematic diagrams illustrating a positional relationship between an illumination optical axis 120 guided to the sample surface by the illumination unit 101 and an illumination intensity distribution shape. The configuration of the illumination unit 101 illustrated in FIG. 2 to FIG. 6 indicates a part of the configuration of the illumination unit 101, and the emitted light adjustment unit 4, the mirror 21, the beam monitor 22, and the like are omitted.

FIG. 2 is a schematic view of a cross section of an incident surface of obliquely incident illumination (a surface that includes an illumination optical axis and a sample surface normal line) in this embodiment. The obliquely incident illumination is inclined with respect to the sample surface in the incident surface. The illumination unit 101 creates a substantially uniform illumination intensity distribution on the incident surface. A length of a portion where the illumination intensity is uniform is about 100 μm to 4 mm in order to inspect a wide area per unit time.

FIG. 3 is a schematic view of a cross section of a plane that includes a sample surface normal line and is perpendicular to an incident surface of obliquely incident illumination in this embodiment. In this plane, the illumination intensity distribution on the sample surface forms an illumination intensity distribution where the illumination intensity around the center is weaker than the illumination intensity at the center. To be more specific, the illumination intensity distribution becomes a Gaussian distribution that reflects the intensity distribution of a light incident on the illumination intensity distribution control unit 7, an intensity distribution similar to a first-class first order Bessel function, or a sinc function that reflects the shape of an aperture of the illumination intensity distribution control unit 7. A length of the illumination intensity distribution in this plane (a length of a region having illumination intensity of 13.5% or more of maximum illumination intensity) is shorter than a length of a portion where the illumination intensity is uniform in the incident surface in order to reduce a haze generated from the sample surface, and is about 2.5 μm to 20 μm.

The illumination intensity distribution control unit 7 a includes optical elements such as an aspherical lens, diffractive optical element, a cylindrical lens array, and a light pipe. These constitutional elements are described later. As illustrated in FIG. 2 and FIG. 3, the optical elements that constitute the illumination intensity distribution control unit 7 are arranged perpendicular to the illumination optical axis.

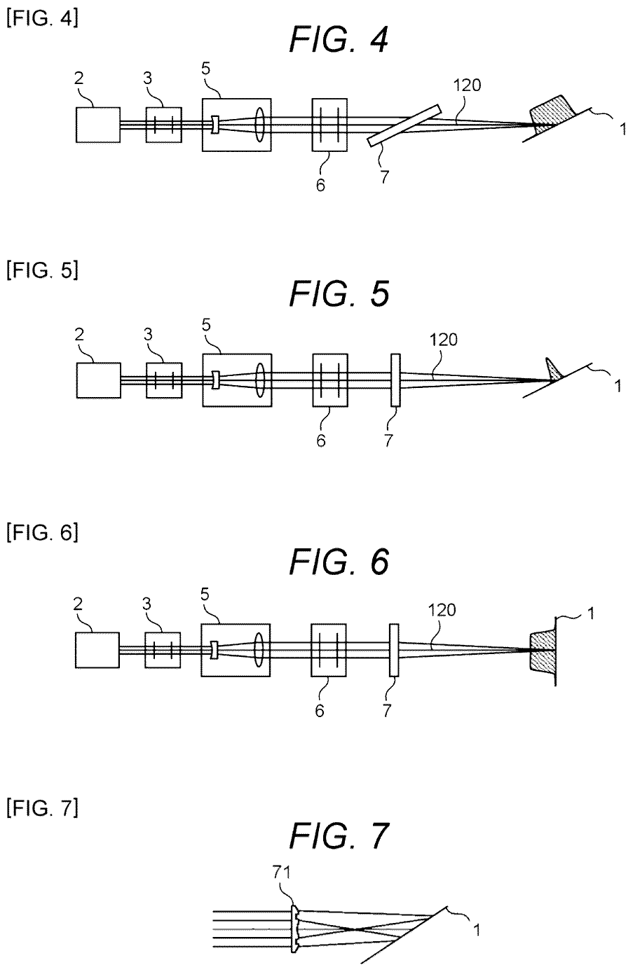

In addition, as illustrated in FIG. 4, it is also possible to arrange the optical element that constitutes the illumination intensity distribution control unit 7 in an inclined manner with respect to the optical axis. Further, as illustrated in FIG. 5 and FIG. 6, the intensity distribution on the incident surface in the obliquely incident illumination illustrated in FIG. 2 and FIG. 3 can be replaced with the intensity distribution on the plane perpendicular to the incident surface. That is, the configuration may also be adopted where a portion on the incident surface where the illumination intensity is uniform is shorter than a portion on a plane perpendicular to the incident surface where the illumination intensity is uniform.

The illumination intensity distribution control unit 7 includes an optical element that acts on a phase distribution and an intensity distribution of incident light. FIG. 7 is a view illustrating an optical element included in the illumination intensity distribution control unit 7 according to this embodiment. As illustrated in FIG. 7, a diffractive optical element 71 (DOE) is used as an optical element that constitutes the illumination intensity distribution control unit 7. A diffractive optical element 71 is an element in which a minute uneven shape having a size substantially equal to or less than a wavelength of light is formed on a surface of a substrate made of a material that transmits an incident light. As a material that transmits an incident light, fused quartz is used for an ultraviolet light. In order to suppress the attenuation of light generated by passing of the light through the diffractive optical element 71, it is preferable to use the diffractive optical element 71 coated with an antireflection film. A lithography method is used to form such a minute uneven shape. The light that becomes a quasi-parallel light after passing through the beam expander 5 is made to pass through the diffractive optical element 71. Accordingly, an illumination intensity distribution on the sample surface corresponding to the uneven shape of the diffractive optical element 71 is formed. The uneven shape of the diffractive optical element 71 is designed and manufactured to a shape obtained based on calculation using Fourier optical theory such that the illumination intensity distribution formed on the sample surface is elongated and uniform within the incident surface. The optical element provided to the illumination intensity distribution control unit 7 includes: a translation adjustment mechanism having two or more axes; and a rotation adjustment mechanism having two or more axes such that the relative position and angle of the optical element with respect to the optical axis of an incident light can be adjusted. Further, the illumination intensity distribution control unit 7 includes a focus adjustment mechanism that moves in the optical axis direction. As an alternative optical element having substantially the same function as the diffractive optical element 71, an aspherical lens, a combination of a cylindrical lens array and a cylindrical lens, or a combination of a light pipe and an imaging lens may be used.

Next, modification of the illumination intensity distribution formed on the sample surface by the illumination unit 101 will be described. As an alternative to the illumination intensity distribution that is long in one direction (linear) and has a substantially uniform intensity in the longitudinal direction, it is also possible to use an illumination intensity distribution with a Gaussian distribution in the longitudinal direction. The Gaussian distribution illumination that is long in one direction is formed by the configuration where the illumination intensity distribution control unit 7 includes a spherical lens and the beam expander 5 forms an elliptical beam that is long in one direction, or the illumination intensity distribution control unit 7 is constituted of a plurality of lenses including a cylindrical lens, or the like. A part or the entirety of the spherical lens or the cylindrical lens that the illumination intensity distribution control unit 7 includes is disposed in parallel to the sample surface. Accordingly, an illumination intensity distribution that is long in one direction on the sample surface and has a narrow width in a direction perpendicular to the one direction is formed. Compared with the case where a uniform illumination intensity distribution is created, a change in the illumination intensity distribution on the sample surface generated by a change in a state of a light that is incident on the illumination intensity distribution control unit 7 is small and hence, the stability of the illumination intensity distribution is high. Further, compared with the case where a diffractive optical element, a micro lens array, or the like is used in the illumination intensity distribution control unit 7, the transmittance of light is high and efficiency is high.

The state of the illumination light in the illumination unit 101 is measured by the beam monitor 22. The beam monitor 22 measures and outputs the position and the angle (traveling direction) of an illumination light that has passed through the emitted light adjustment unit 4 or the position and the wavefront of an illumination light that is incident on the illumination intensity distribution control unit 7. The measurement of the position of an illumination light is performed by measuring the centroid position of the light intensity of the illumination light. As a specific position measurement unit, an optical position sensor (position sensitive detector (PSD)) or an image sensor such as a CCD sensor or a CMOS sensor is used. The measurement of an angle of an illumination light is performed by an optical position sensor or an image sensor disposed at a position remoter from a light source than the position measurement unit or at a condensing position where condensing of light is performed by a collimating lens. The illumination light position and the illumination light angle detected by the above-mentioned sensors are input to the control unit 53 and are displayed on the display unit 54. In a case where the illumination light position is shifted from a predetermined position or the illumination light angle is shifted from a predetermined angle, the illumination light position or angle is adjusted so as to return the position or the angle to a predetermined position or angle at the emitted light adjustment unit 4.

The wavefront measurement of an illumination light is performed so as to measure the parallelism of the light incident on the illumination intensity distribution control unit 7. In a case where it is found by the wavefront measurement that a light that is incident on the illumination intensity distribution control unit 7 is not a quasi-parallel light but is diverging or converging, the incident light can be brought close to a quasi-parallel light by displacing a lens group of the beam expander 5 in a preceding stage in the optical axis direction. Further, in a case where it is found by the wavefront measurement that a wavefront of a light that is incident on the illumination intensity distribution control unit 7 is partially inclined, a spatial light phase modulation element that is a type of spatial light modulator (SLM) is inserted into a stage preceding the illumination intensity distribution control unit 7. By giving an appropriate phase difference for each position of a luminous flux cross section such that the wavefront is flat, the wavefront can be made flat, that is, an illumination light can be made close to a quasi-parallel light. With the use of the above-mentioned wavefront accuracy measurement/adjustment means, the wavefront accuracy (deviation from a predetermined wavefront (a design value or an initial state)) of a light incident on the illumination intensity distribution control unit 7 is suppressed to λ/10 rms or less.

The illumination intensity distribution on the sample surface adjusted by the illumination intensity distribution control unit 7 is measured by an illumination intensity distribution monitor 24. As illustrated in FIG. 1, also in the case of using vertical illumination, the illumination intensity distribution on the sample surface adjusted by the illumination intensity distribution control unit 7v is measured by the illumination intensity distribution monitor 24 in the same manner. The illumination intensity distribution monitor 24 forms an image of a sample surface on an image sensor such as a CCD sensor or a CMOS sensor via a lens and detects the sample surface as an image. The image of the illumination intensity distribution detected by the illumination intensity distribution monitor 24 is processed by the control unit 53. That is, the centroid position, the maximum intensity, the maximum intensity position, a width and a length of the illumination intensity distribution (a width and a length of an illumination intensity distribution region of a predetermined intensity or more or of a predetermined ratio or more with respect to a maximum intensity value) and the like are calculated, and these values are displayed together with a contour shape, a cross-sectional waveform and the like of the illumination intensity distribution on the display unit 54.

In a case where the obliquely incident illumination is performed, due to a displacement of a height of a sample surface, the disturbance of the illumination intensity distribution is generated by the displacement of the position of the illumination intensity distribution and the disturbance of the illumination intensity distribution is generated by defocusing. In order to suppress the disturbance of the illumination intensity distribution, a height of a sample surface is measured, and in a case where the height of the sample surface is deviated, the deviation is corrected by the illumination intensity distribution control unit 7 or by the height adjustment of the stage 104 along the Z-axis.

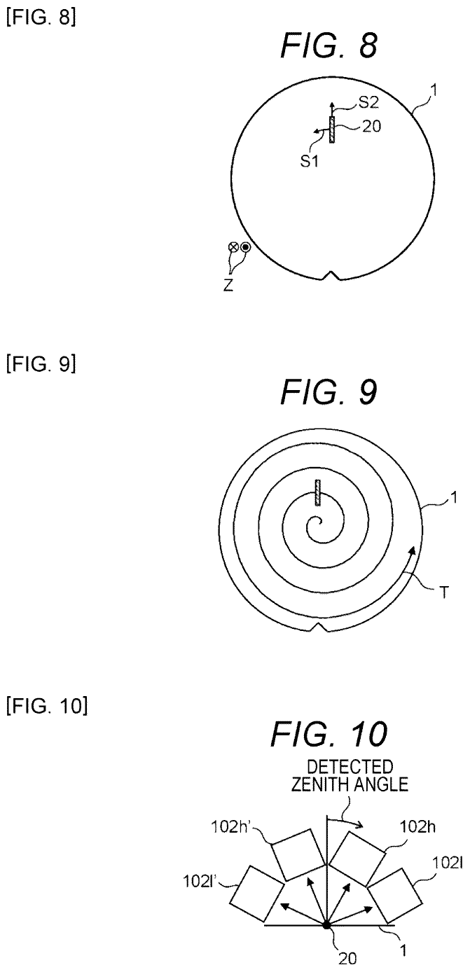

An illuminance distribution shape (an illumination spot 20) formed on the sample surface by the illumination unit 101 and a sample scanning method will be described with reference to FIG. 8 and FIG. 9.

As illustrated in FIG. 8, a circular semiconductor silicon wafer is assumed as the sample 1. The stage 104 includes a translation stage, a rotation stage, and a Z stage (none of which are illustrated) for adjusting the height of the sample surface. The illumination spot 20 has the illumination intensity distribution that is long in one direction as described above. Such a direction is indicated by S2, and a direction substantially orthogonal to the direction S2 is indicated by S1. Scanning is performed in the circumferential direction S1 of a circle about an axis of rotation of the rotation stage by the rotational movement of the rotation stage, and in the translational direction S2 of the translation stage by the translational movement of the translation stage.

Then, as illustrated in FIG. 9, by performing scanning by a distance equal to or less than a length of the illumination spot 20 in the longitudinal direction in the scanning direction S2 during one rotation of the sample by scanning in the scanning direction S1, the illumination spot draws a spiral trajectory T on the sample 1 and hence, the entire surface of the sample 1 is scanned.

Next, pupil branching in the detection unit 102 will be described. The plurality of detection units 102 are arranged so as to detect scattered lights in a plurality of directions emitted from the illumination spot 20. An arrangement example of the detection units 102 with respect to the sample 1 and the illumination spot 20 will be described with reference to FIG. 10 to FIG. 12.

FIG. 10 illustrates a side view of the arrangement of the detection units 102. An angle made by a detection direction by the detection unit 102 (a center direction of a detection aperture) with respect to a normal line of the sample 1 is defined as a detection zenith angle. The detection unit 102 is constituted by appropriately using a high angle detection unit 102h having a detection zenith angle of 45 degrees or less, and a low angle detection unit 102l having a detection zenith angle of 45 degrees or more, and also a high angle detection unit 102h′ and a low angle detection unit 102l′ that are symmetrically arranged with the high angle detection unit 102h and the low angle detection unit 102l with respect to a normal line of the sample 1. Each of the high angle detection unit 102h and the low angle detection unit 102l detects scattered lights using a common objective lens and the scattered lights are branched on a Fourier plane of the objective lens. Further, the detection unit 102 includes a plurality of detection units so as to cover scattered lights in multiple directions.

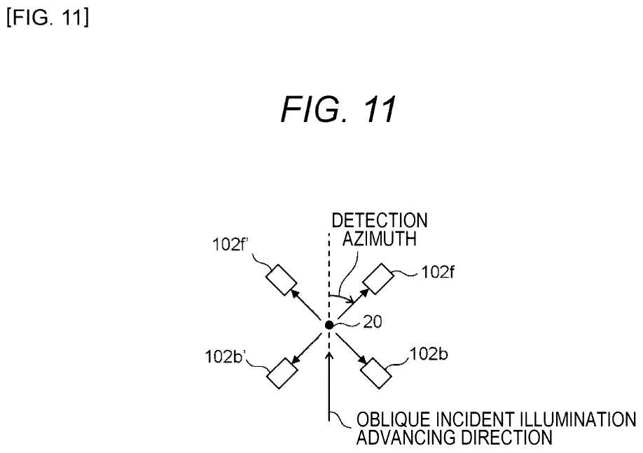

FIG. 11 is a plan view of the arrangement of the detection units 102. In a plane parallel to the surface of sample 1, an angle made by a traveling direction of obliquely incident illumination and a detection direction is defined as a detection azimuth angle. The detection unit 102 appropriately includes a front detection unit 102f, a rear detection unit 102b, and also a front detection unit 102f′ and a rear detection unit 102b′ that are symmetrically arranged with the front detection unit 102f and the rear detection unit 102b with respect to the illumination incident surface. For example, the front detection unit 102f is arranged with a detection azimuth angle of 0 degrees or more and 90 degrees or less, and the rear detection unit 102b is arranged with a detection azimuth angle of 90 degrees or more and 180 degrees or less. A low angle detection unit and a high angle detection unit are disposed at each detection azimuth. The present invention is not limited to such a case, and the number and the positions of the detection units may be appropriately changed.

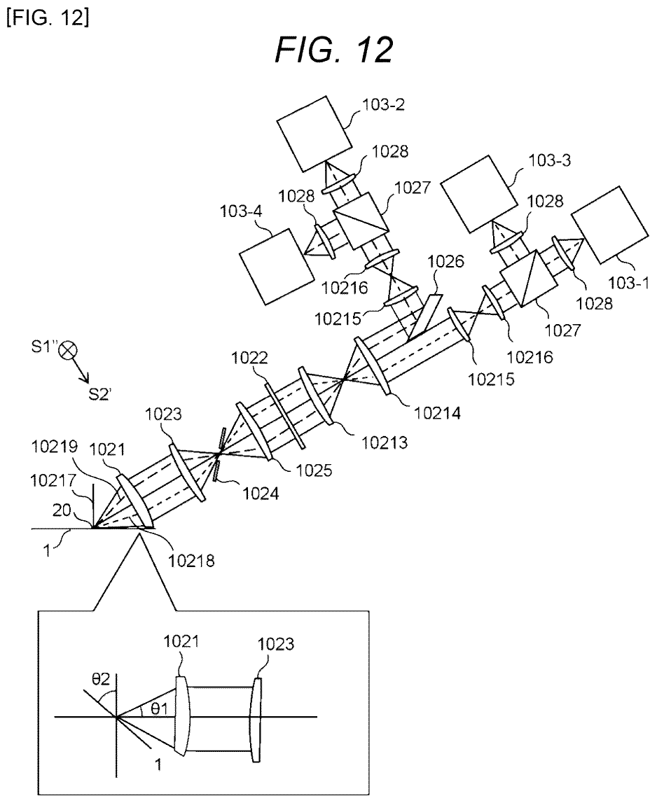

FIG. 12 is a configuration view of the detection unit according to this embodiment. In FIG. 12, scattered lights generated from illumination spot 20 are condensed by an objective lens 1021. In order to efficiently detect the scattered lights, the detection NA of the objective lens 1021 is preferably set to 0.3 or more. To prevent a lower end of the objective lens from interfering with the sample 1, the lower end of the objective lens 102l is notched when necessary. An imaging lens 1023 forms an image of the illumination spot 20 at the position of an aperture 1024. The aperture 1024 is an aperture that is set to allow only lights in a region detected by the photoelectric conversion unit 103 to pass therethrough with respect to an image formed by the illumination spot 20. In a case where the illumination spot 20 has a profile of a Gaussian distribution in the S2 direction, the aperture 1024 allows only a central portion having a strong light amount in the S2 direction in the Gaussian distribution to pass therethrough, and blocks a region having a weak light amount at a beam end. Further, in the S1 direction, the size of the aperture 1024 is substantially set to the same size as an image formed by the illumination spot 20 thus suppressing disturbance such as air scattering generated when the illumination passes through air. Reference numeral 1025 indicates a condenser lens, and the condenser lens 1025 condenses a formed image of the aperture 1024 again. The Fourier plane of an objective lens 102l is relayed by the condenser lens 1025, and a polarization control filter 1022 is disposed on the Fourier plane. As the polarization control filter 1022, for example, a ½ wavelength plate where a rotation angle can be controlled by a drive mechanism such as a motor is adopted.

A pupil surface is relayed by a relay lens that includes the imaging lens 1023, the condenser lens 1025, an imaging lens 10213, and a condenser lens 10214. A knife edge 1026 (branching optical member) is disposed on the pupil surface. The knife edge 1026 branches the scattered lights condensed on the high angle detection unit 102h having a detection zenith angle of 45 degrees or less and on the low angle detection unit 102l having a detection zenith angle of 45 degrees or more. The angle made by a principal ray of the branched scattered light and a normal line of the sample surface differs. In FIG. 12, the angle made by a principal ray 10218 of the scattered light detected by the low angle detection unit 102l and a normal line 10217 of the sample surface is set larger than an angle made by a principal ray 10219 of the scattered light detected by the high angle detection unit 102h and a normal line 10217 of the sample surface. A branching angle of a detection zenith angle is not necessarily 45 degrees, and can be appropriately changed. Further, a polarization beam splitter 1027 is disposed on each of the pupil surfaces that are relayed by an imaging lens 10215 and a condenser lens 10216 and are branched. With such a configuration, the light whose polarization direction has been converted by the polarization control filter 1022 is separated along the polarization direction. In this case, the low angle detection unit 102l performs the detection using photoelectric conversion units 103-1, 103-3. The high angle detection unit 102h performs the detection using photoelectric conversion units 103-2, 103-4. Reference numeral 1028 indicates an imaging lens, and forms an image of the illumination spot 20 on the photoelectric conversion unit 103. A cylindrical lens may be used as the imaging lens 1028. In this case, imaging in only one direction can be performed.

In this embodiment, the description is made with respect to a case where, among the lights condensed at the objective lens 102l by the combination of the polarization control filter 1022 and the polarization beam splitter 1027, only the light in a specific polarization direction is detected by the photoelectric conversion unit 103. However, alternatively, for example, the polarization control filter 1022 may be formed of a wire grid polarizing plate having a transmittance of 80% or more, and only light in a desired polarization direction may be extracted without using the polarization beam splitter 1027. Further, by using a difference between a polarization of a background scattered light and the polarization of a scattered light generated from a defect, it is also possible to use a wavelength plate that attenuates only the background scattered light as the polarization control filter 1022. In this case, polarization components that attenuate in a Fourier plane differ and hence, it is necessary to adopt a split wavelength plate. In a case of blocking a polarization component that does not need to be detected, a beam diffuser is used instead of the imaging lens 1028 so as to prevent an unnecessary light from becoming a stray light.

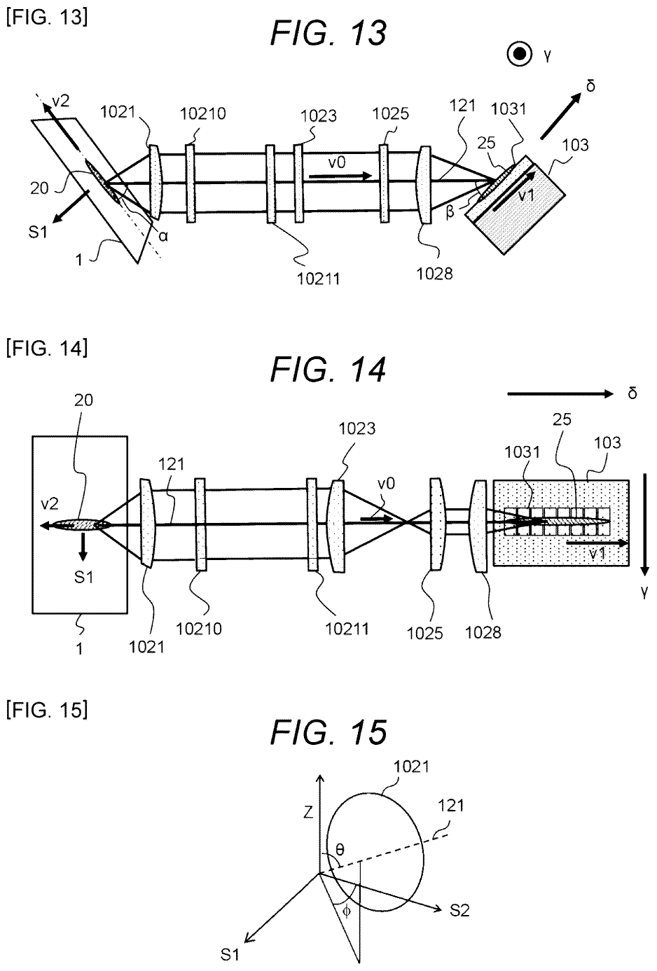

Next, the configuration where the photoelectric conversion unit 103 is inclined with respect to an optical axis will be described. FIG. 13 is a view illustrating the arrangement of an illumination spot and a photoelectric conversion unit according to this embodiment. FIG. 14 is a view of the arrangement illustrated in FIG. 13 as viewed from above the plane of FIGURE. As illustrated in FIG. 13 and FIG. 14, an optical axis 121 is inclined with respect to a normal direction of a light receiving unit 1031. The light receiving unit 1031 of the photoelectric conversion unit 103 is arranged such that a linear illumination spot 20 radiated on the surface of the sample 1 becomes parallel to a longitudinal direction δ of an optical image 25 formed on the light receiving unit 1031 by the detection unit 102. Cylindrical lenses 10210 and 10211 that form a pair constitute a cylindrical beam expander, and set the spreading of an optical image 25 formed by the illumination spot 20 in a lateral direction γ smaller than the spreading of the optical image 25 in a longitudinal direction.

The photoelectric conversion unit 103 images the optical image 25 and outputs the optical image 25 as an electric signal. The photoelectric conversion unit 103 includes an array-shaped light receiving unit and an antireflection film at a position conjugate with the illumination spot that is radiated on the surface of the sample 1. The light receiving surface of the photoelectric conversion unit 103 is not conjugate with the sample surface in the lateral direction γ. However, the lateral direction γ is also the lateral direction of the illumination spot 20 and hence, an image height of the optical image 25 is low whereby defocusing hardly occurs. Accordingly, by increasing an imaging magnification of the optical image 25 in the lateral direction γ, the variation in an incident angle on the light receiving unit 1031 can be reduced.

FIG. 15 is a schematic view illustrating a three-dimensional arrangement of the sample 1 and the detection unit 102 in this embodiment. As illustrated in FIG. 15, the optical axis 121 of the detection unit 102 indicated with reference to the objective lens 102l is inclined by an angle θ with respect to a normal direction Z of the sample 1. The projection of the optical axis 121 onto the sample surface is inclined by an angle 9 with respect to the longitudinal direction S2 of the illumination spot 20.

Assuming that an optical axis 121 for detecting a light by the detection unit 102 is shifted by an angle θ with respect to a normal direction of the sample 1 and is shifted by an angle φ with respect to the longitudinal direction of the illumination spot 20, in a three-dimensional space, this optical axis 121 is expressed by a vector v0 in the following formula (1).

$$\begin{matrix}[ Formula 1 ] & \\ v 0 = [ \begin{matrix}sin θ sin ϕ & sin θ cos ϕ & cos θ\end{matrix} ] & ( 1 )\end{matrix}$$

An angle α made by the vector v0 and a longitudinal direction of the illumination spot 20 is obtained by the following formula (2).

$$\begin{matrix}[ Formula 2 ] & \\ α = arc cos ( sin θ cos ϕ ) & ( 2 )\end{matrix}$$

At this point of time, the defect inspecting device 100 detects a section of 2L in the longitudinal direction of the illumination spot 20 by the photoelectric conversion unit 103. An operation distance (a distance between the sample 1 and the detection unit 102) changes as ΔZ expressed by the following formula (3) based on a position x from the center of a field of view.

$$\begin{matrix}[ Formula 3 ] & \\ Δ z = x ( sin θ cos ϕ ) , \vert x \vert < L & ( 3 )\end{matrix}$$

The imaging magnification M is determined by the objective lens 102l and the imaging lens 1028. In this embodiment, the position of the formed image is expressed by the following formula (4).

$$\begin{matrix}[ Formula 4 ] & \\ Δ Z = {M}^{2} x ( sin θ cos ϕ ) , \vert x \vert < L & ( 4 )\end{matrix}$$

In general, a line sensor is disposed so as to be orthogonal to an optical axis that is the center of a luminous flux that the imaging lens emits. However, in this embodiment, by inclining the photoelectric conversion unit 103, the formed image detection without defocusing is realized regardless of a change in an operation distance in the field of view. In this case, the optical axis 121 that is incident on the photoelectric conversion unit 103 and a pixel layout vector v1 on a light receiving surface are within a plane formed by expanding a longitudinal direction of the illumination spot 20 and a vector v0, and an angle β made by the vector v1 and the vector v0 is set so as to satisfy the following formula (5).

$$\begin{matrix}[ Formula 5 ] & \\ tan α = M * tan β & ( 5 )\end{matrix}$$

In the above formula (5), an angle α is an angle made by a vector v2 and the vector v0, and satisfies the formula (6).

$$\begin{matrix}[ Formula 6 ] & \\ cos α = sin θ * cos ϕ & ( 6 )\end{matrix}$$

From the formula (5), it is understood that the larger an imaging magnification M, the smaller an angle β made by the vector v0 and the vector v1 becomes so that an incident angle becomes large. When M=2, a light beam having the largest incident angle is incident on the photoelectric conversion unit 103 at an angle close to 90 degrees. An absorption rate of an antireflection film 1033 of the photoelectric conversion unit 103 has an incident angle dependency, and the absorption rate becomes very small at an incident angle close to 90 degrees. In order to prevent such a phenomenon, the imaging magnification M is set to two times or less.

Under such a condition, an angle made by the optical axis 121 incident on the photoelectric conversion unit 103 from the imaging lens 1028 and the vector v1 can be increased to a maximum angle. When the numerical aperture of an incident luminous flux of the objective lens 102l is N, the spread of a luminous flux emitted to the photoelectric conversion unit 103 is obtained by multiplying the spread of the luminous flux emitted to the imaging lens 1028 by a reciprocal of the imaging magnification M.

In a case where a lens having a large numerical aperture is adopted as the objective lens 102l particularly in order to set the imaging magnification M to two times or less, lights from wide directions are incident on the photoelectric conversion unit 103. Due to a characteristic of the antireflection film 1033, when an incident angle range of light to the photoelectric conversion unit 103 is wide, a light absorption rate of the photoelectric conversion unit 103 is decreased and hence, it is difficult to obtain high sensitivity. In order to prevent such a phenomenon, the imaging magnification M is set to one time or more. As a result, the angle β becomes smaller than the angle α. In a typical case, by setting a magnification to about 1.3 times, the angle β becomes smaller by 5 degrees or more.

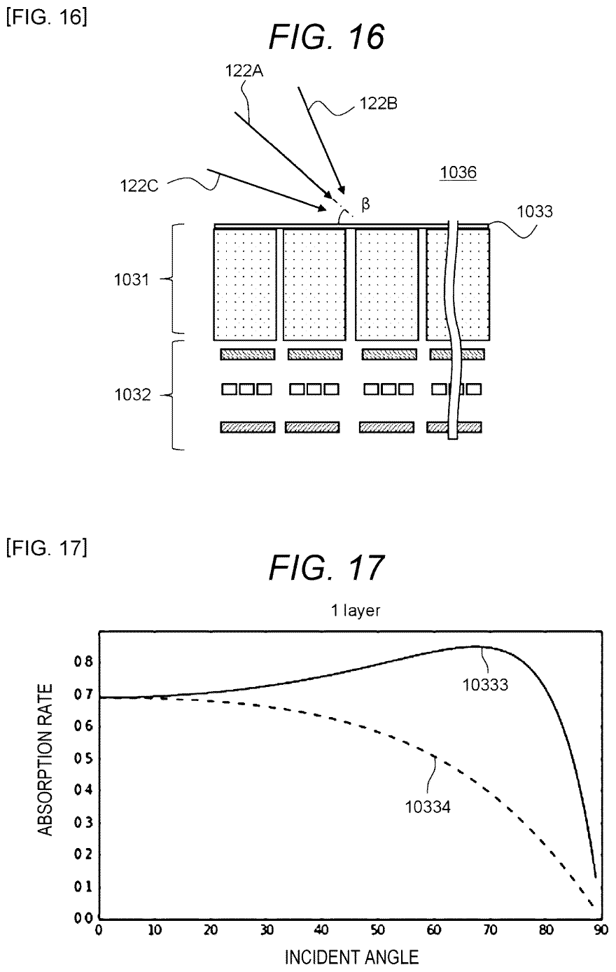

FIG. 16 is a cross-sectional configuration view of the imaging sensor 1036 that constitutes the photoelectric conversion unit 103 in this embodiment. In FIG. 16, the imaging sensor 1036 is formed by stacking an antireflection film 1033, a light receiving unit 1031, and a wiring unit 1032 in order from a surface of the imaging sensor 1036. The incident lights 122A to 122C are lights incident on the imaging sensor 1036.

The incident light 122A is a light on the optical axis 121 illustrated in FIG. 13 and FIG. 14. The incident lights 122B and 122C are lights incident from angles different from that of the optical axis 121. The antireflection film 1033 is a film for preventing the surface reflection of each of the incident lights 122A to 122C. The light receiving unit 1031 has an array shape, and performs photoelectric conversion for each divided region, is, for each pixel. The wiring unit 1032 independently extracts electricity output from the light receiving unit 1031 to the outside. A sensor that has a structure where the light receiving unit 1031 is disposed on the light incident side of the wiring unit 1032 is known as a back side illumination sensor. In this embodiment, the incident light is incident while being shifted from the normal direction of the light receiving unit by a predetermined angle. Accordingly, in a CMOS imaging sensor known as a FSI (front side Illumination) and having a structure where a wiring unit is on a light incident side, light is absorbed by the wiring unit and hence, a sufficient light cannot be made incident on a light receiving unit.

As indicated by the incident lights 122A to 122C, the lights are incident on the light receiving unit 1031 from various directions. Accordingly, the antireflection film 1033 cannot obtain good sensitivity to the incident lights 122A to 122C unless the antireflection film 1033 has high absorption rate.

FIG. 17 is a graph showing characteristics of the antireflection film 1033 that is formed of one layer made of hafnium oxide HfO2 having a thickness of 25 nm. The horizontal axis of the graph represents an incident angle, and a vertical axis of the graph represents absorption rate. A curve 10333 indicates a characteristic of the absorption rate of an S-polarized light. A curve 10334 indicates a characteristic of the absorption rate of a P-polarized light. The absorption rate of the P-polarized light decreases as an incident angle increases. The absorption rate decreases to 0.5 in the vicinity of an incident angle of 60 degrees.

Further, in the S-polarized light, the incident angle has increased to about 70 degrees, and exhibits the absorption rate of 70% or more in a region where the incident angle falls within a range of from 0 to 80 degrees. However, to realize the formed image detection without defocusing regardless of a change in an operation distance in the field of view, it is necessary to incline the photoelectric conversion units 103-1, 103-2 by a predetermined angle. That is, it is desirable that a normal line of the light receiving surface of the photoelectric conversion unit 103-1 is inclined from the optical axis 121-1 of the detection unit 102-1 by, for example, 10 to 80 degrees.

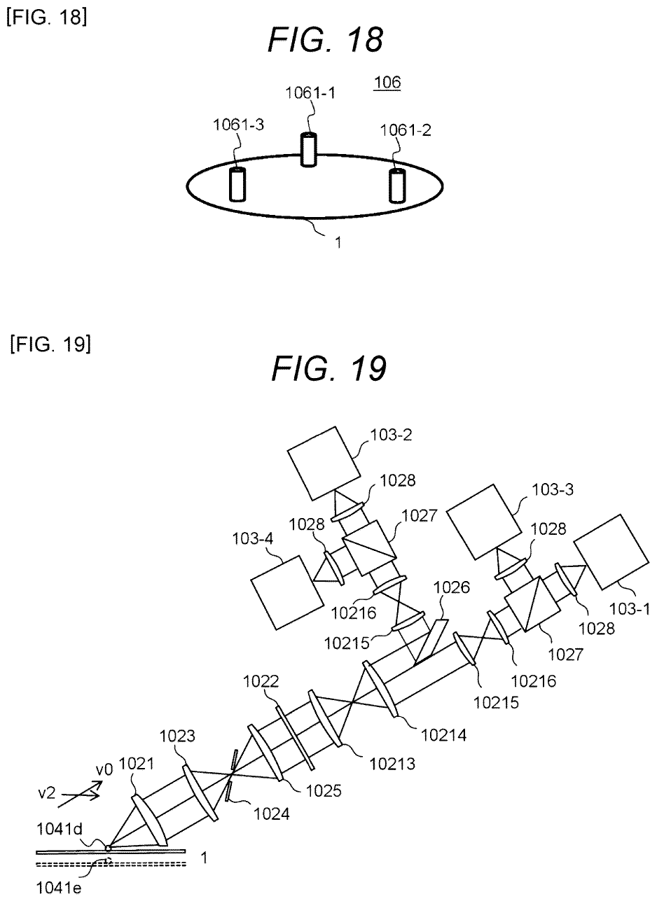

FIG. 18 is a schematic configuration view of a sample height detection unit according to this embodiment. In FIG. 18, the sample height detection unit 106 measures the height of the sample at a plurality of points in real time during the inspection using height sensors 1061-1, 1061-2, and 1061-3 such as a plurality of laser interferometers. By measuring the height displacement of the inspection region in advance before detecting the scattered lights in the inspection region, it is possible to prevent a delay at the time of inspection.

In a case where the obliquely incident illumination is performed, due to the displacement of the height of the sample surface, the disturbance of the illumination intensity distribution occurs due to the displacement of the position of the illumination intensity distribution and defocusing. In this embodiment, in order to suppress such disturbance of the illumination intensity distribution, the height of the sample surface is measured, and in a case where the height of the sample surface is deviated, the deviation of an image caused by the displacement of the sample surface is corrected by the illumination intensity distribution control unit 7 or the height adjustment of the stage 104 along the Z-axis.

At the time of measurement, the height of the sample surface in the Z-axis direction is displaced by several tens to several hundreds μm at a frequency of several tens to several hundreds Hz. As causes that generate the displacement of the sample surface, the displacement of the rotation axis, the vibration of the stage and the like are named. Due to the Z-axis displacement of the sample surface, the position of an image formed on the sensor surface is displaced. The displacement amounts of the respective divided images obtained by the Z-axis displacement Aw are expressed by the formula (7).

$$\begin{matrix}[ Formula 7 ] & \\ Δ u = Δ w ( sin ( \frac{π}{2} - θ 2 ) - tan θ 1 ( i ) cos ( \frac{π}{2} - θ 2 ) ) & ( 7 )\end{matrix}$$

The displacement amounts are proportional to Δu, and differ for respective detection elevation angles.

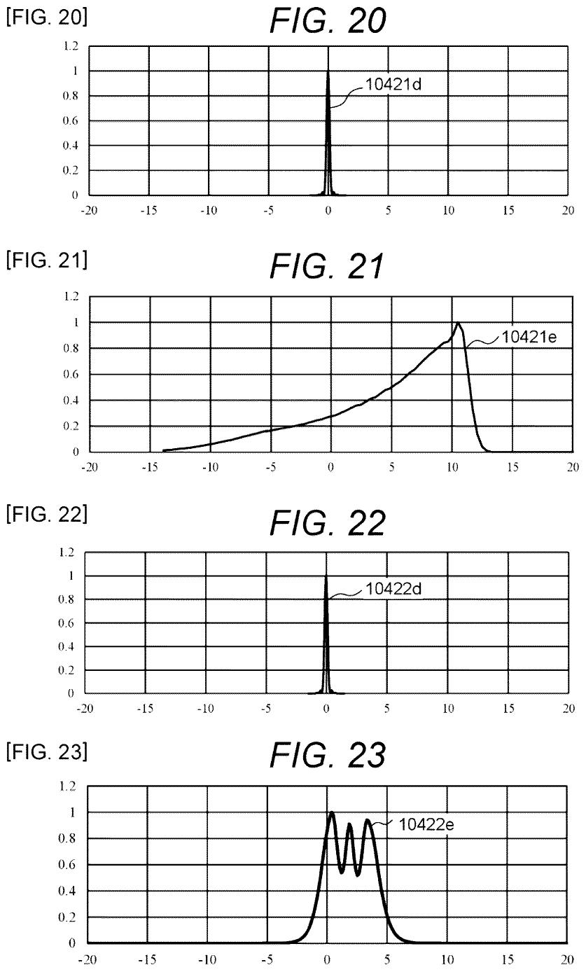

FIG. 19 to FIG. 23 are views for describing the displacement of the sample surface in the height direction and the imaging position displacement. As illustrated in FIG. 19, when the height of the sample surface is displaced and a foreign matter 1041d to be observed is displaced to 1041e, in the photoelectric conversion unit 103-2 where scattered lights having a large detection vertex angles form an image, the foreign matter 1041d is imaged as a formed image 10421d in FIG. 20, while the foreign matter 1041e is imaged as a formed image 10421e in FIG. 21 when the height of the sample is displaced. The horizontal axis of each graph is the distance in the δ direction of the light receiving surface of the photoelectric conversion unit 103. Between the formed image 10421d and the formed image 10421e, the imaging positions on the respective formed images on the light receiving surfaces largely differ from each other. On the other hand, in the photoelectric conversion unit 103-1 in which scattered light having a small detection vertex angle is imaged, the foreign matter 1041d is imaged as the formed image 10422d in FIG. 22, whereas the foreign matter 1041e is imaged as the formed image 10422e in FIG. 23 when the height of the sample is displaced. In this case, because of the direction of a principal ray, the positional deviation is small compared with divided images having small detection elevation angles. As a result, when all divided images are integrated, the image is blurred and hence, sensitivity is lowered.

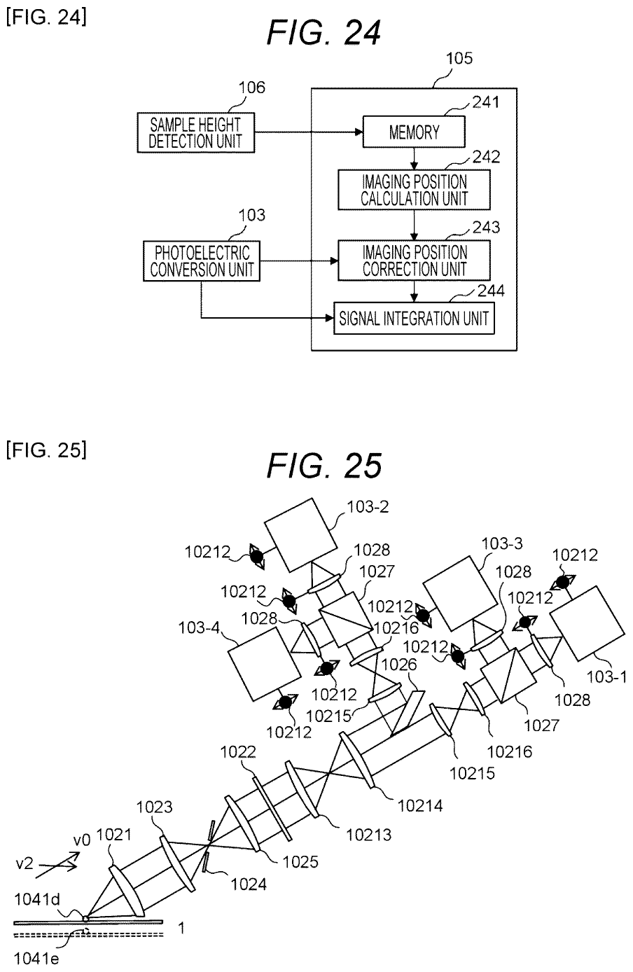

FIG. 24 is a functional block diagram of a signal processing unit 105 according to this embodiment. The sample height detection unit 106 (for example, an optical sensor) detects the Z-axis displacement of a detection area on the sample surface in real time, and stores the Z-axis displacement of the detection area in the memory 241.

The imaging position calculation unit 242 calculates a shift of the imaging position from the Z-axis displacement of the detection area. In one or more of detection units out of the detection units 102l having a large detection vertex angle and the detection units 102h having a small detection vertex angle, that constitute the detection units 102f, 102b, 102f′, and 102b′ illustrated in FIG. 11, image formation in a direction in which the detection vertex angle is large and a signal in a direction where a detection vertex angle is small are divided into two or more groups and are integrated by the photoelectric conversion unit 103.

The imaging position correction unit 243 corrects the imaging position displacement of the signals having a large imaging position displacement (that is, a group including many signals of scattered lights each having a large detection vertex angle), and the signal integration unit 244 integrates images of all groups. With such configuration, lowering of sensitivity due to the imaging position displacement is prevented.

The mechanism illustrated in FIG. 24 can be operated in real time at a frequency of several tens to several hundreds Hz during the inspection so as to prevent lowering of sensitivity of the Z-axis displacement due to the displacement.

The signal integration unit 244 can also operate as follows. The signal integration unit 244 groups scattered lights having similar detection elevation angles (a difference between the detection elevation angles being within a predetermined range) thus forming one or more scattered light groups. The signal integration unit 244 first integrates the images of the members in the group for each group to generate temporarily integrated images the number of which is equal to the number of groups. The imaging position correction unit 243 corrects the imaging position for each temporarily integrated image (that is, the group). The signal integration unit 244 generates a final integrated image by integrating the respective temporarily integrated images again after correcting the imaging position.

To summarize the above, the defect inspecting device 10 is configured such that the scattered lights having the similar incident angles with respect to the condenser lens 1025 detect and integrate the foreign matters at the same position of the sample 1 on the same coordinates of the light receiving unit surfaces of the photoelectric conversion units 103-1 and 103-2 after being branched by the knife edge 1026, and with respect to the scattered lights having the large detection vertex angle, the imaging position displacement is more largely corrected. With such a configuration, even a minute defect can be accurately detected, and an image shift caused by displacement of the sample surface in the Z direction can be accurately corrected.

As described above, according to this embodiment, it is possible to perform discrimination from the background scattered lights by dividing an optical path by an optical dividing unit disposed at the pupil position of the light collecting unit, or at the position where the pupil is relayed, or in the vicinity of these positions. Further, the photoelectric conversion unit is arranged in a conjugate manner with respect to the sample, is inclined with respect to the optical axis, detects the image formation without causing blurring in the longitudinal direction of the illumination, and enables image formation detection from a direction not orthogonal to the longitudinal direction of the illumination. As a result, the imaging detection system can be arranged without being restricted by an azimuth angle. Accordingly, all lights scattered from the minute defects existing on the sample surface can be substantially imaged and hence, the detection is realized at a high speed and with high sensitivity.

### Second Embodiment

In the first embodiment, the description has been made with respect to the case where the signal processing unit 105 corrects the imaging position displacement. However, in this embodiment, a change in a point spread function (PSF) of image formation that is blurring of image formation is corrected by adjusting the position of an optical element of a detection optical system.

FIG. 25 is a configuration view of a detection unit 102 according to this embodiment, and is a view for explaining the displacement of a sample surface in a height direction and the details of an optical element adjustment mechanism. In FIG. 25, the same constitutional elements as the constitutional elements illustrated in FIG. 19 are denoted by the same reference numerals, and the description of such constitutional elements will be omitted.

Even in a case where a displacement amount of a height of the sample is the same due to the difference in a principal ray, can be understood by comparing a formed image 10421e illustrated in FIG. 21 and the formed image 10422e illustrated in FIG. 23, the respective PSFs largely differ from each other. This difference in PSF causes lowering of sensitivity during integration.

In FIG. 25, a mechanism 10212 that adjusts the position along the optical axis direction is attached to at least one out of the imaging lens 1028 and the photoelectric conversion units 103-1 and 103-2. As the mechanism 10212 that adjusts the position, for example, a micrometer equipped with a piezo motor can be used.

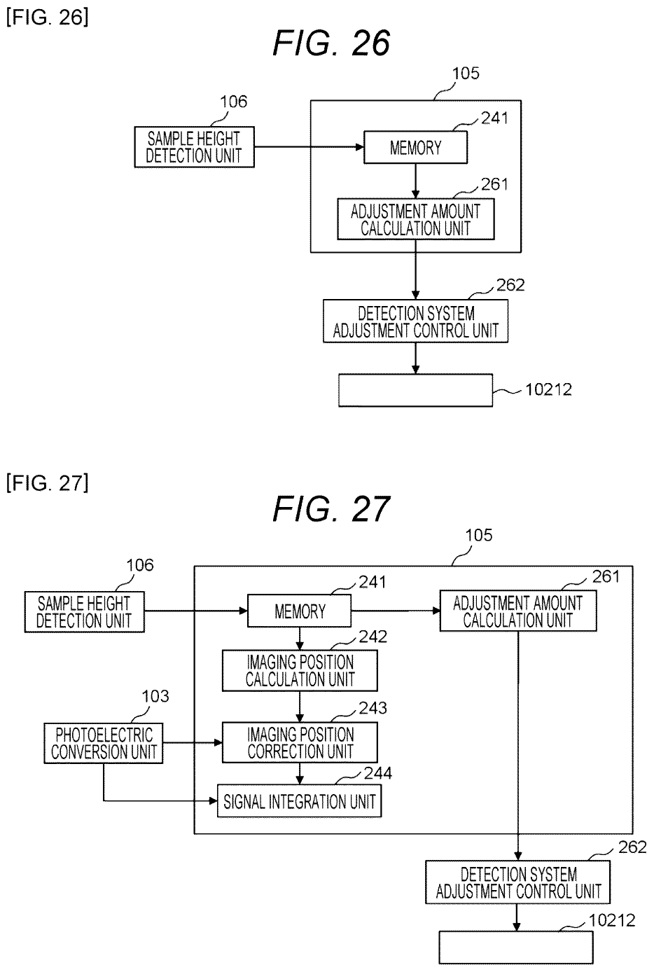

FIG. 26 is a functional block diagram of a signal processing unit 105 according to this embodiment. An adjustment amount calculation unit 261 calculates an adjustment distance in the optical axis direction from a Z-axis displacement of a sample surface stored in a memory 241, and a detection system adjustment control unit 262 adjusts a part (any one or more optical elements) of a detection unit 102 in the optical axis direction. As a result, the difference between the changes in the PSF due to the Z-axis displacement of the sample surface decreases, blurring of the integrated image decreases and hence, lowering of sensitivity can be prevented.

In FIG. 25, the optical element to which the position adjustment is to be applied can be determined as follows. The operation of a synthetic lens when an optical system from an objective lens 102l to an imaging lens 1028 is regarded as a synthetic lens can be calculated. Accordingly, when the position of any one of the optical elements is moved, the operation of the synthetic lens generated by the movement can also be calculated. For example, the adjustment amount calculation unit 261 can calculate a change in each PSF by calculating an operation of a synthetic lens when any one or more of the optical elements from the objective lens 102l to the photoelectric conversion unit 103 are randomly selected and the positions of these elements are moved. The adjustment amount calculation unit 261 can determine the optical element whose position is to be adjusted and a position movement amount of the optical element by searching for a combination of the optical element and a position adjustment amount by which a change in each PSF is minimized. The search may be performed randomly, or may be performed using a search algorithm based on an appropriate evaluation function or the like. Alternatively, if an optical element whose PSF should be preferentially corrected is determined in advance (for example, priority should be given to an optical element having a small size), the position adjustment may be performed in order starting from such an optical element.

The signal processing unit 105 may simultaneously perform the position adjustment of the optical element and the signal processing described in the first embodiment thus preventing lowering of sensitivity. FIG. 27 illustrates a functional block diagram of the signal processing unit in this case. In the imaging position correction unit 243 and the adjustment amount calculation unit 261, a correction amount and an adjustment amount for each sample height are determined in advance. By setting the correction amount and the adjustment amount so as to minimize a change in the imaging position displacement and a change in PSF generated by a change in each sample height, it is possible to prevent lowering of sensitivity.

### Third Embodiment

In this embodiment, the relaxation of a change in sensitivity generated by the sample height displacement using a cross-correlation filter will be described.

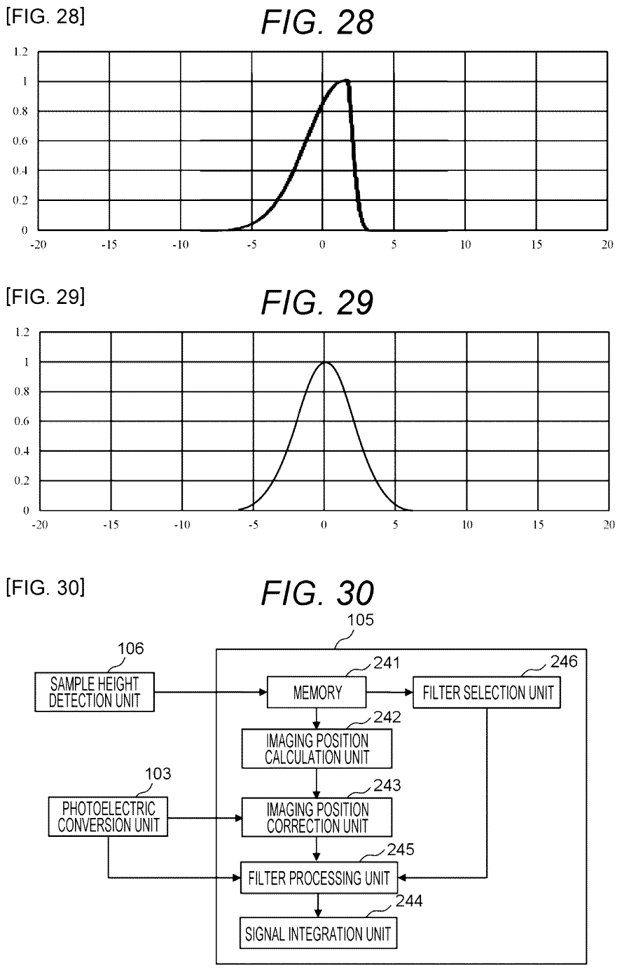

FIGS. 28 and 29 illustrate characteristics of the cross-correlation filter in this embodiment. FIG. 28 illustrates the cross-correlation filter corresponding to a formed image 10421e of scattered lights having a large variation amount of the PSF and a large detection vertex angle. FIG. 29 illustrates the cross-correlation filter corresponding to the formed image 10422e of scattered lights having a small detection vertex angle. A Gaussian fitting curve of 4σ of each formed image is obtained, and convolution is performed on each signal after the imaging position is corrected by an imaging position correction unit 243. This convolution is similarly performed before and after the height displacement of a sample occurs. As a result, the signal intensities of the formed images 10421d and 10422d before the height displacement of the sample is generated are blurred. However, an amount of difference in signal intensity before and after the height displacement of the sample can be reduced. That is, the signal processing unit includes a cross-correlation filter that is a mechanism for reducing a difference between a signal at the time of defocusing and a signal at the time of focusing.

The shape of the cross-correlation filter can be arbitrarily determined by confirming in advance a change in an image formed due to the height displacement of a sample for each detection vertex angle or each detection azimuth angle. Further, by arbitrarily determining the shape of the cross-correlation filter with respect to a height displacement amount of a sample detected by the sample height detection unit 106 and by multiplying the shape with a signal of each formed image, an amount of difference in signal intensity due to a height displacement of a sample can be reduced.

FIG. 30 is a functional block diagram of a signal processing unit according to this embodiment. In FIG. 30, a sample height detection unit 106 (for example, an optical sensor) detects the Z-axis displacement of a detection area on a sample surface in real time, and stores the Z-axis displacement of the detection area in a memory 241. Signals whose imaging positions are respectively corrected by the imaging position correction unit 243 are convolved with a cross-correlation filter by a filter processing unit 245. The convoluted signals are integrated by a signal integration unit 244. Further, it is also possible that the filter selection unit 246 selects the cross-correlation filter corresponding to a height displacement amount of the sample, and the filter processing unit 245 performs processing using the selected filter. The mechanism illustrated in FIG. 30 can be operated in real time at a frequency of several tens to several hundreds Hz during the inspection so as to prevent change of sensitivity before and after the Z-axis displacement due to the inspection.

### Fourth Embodiment

In the first to third embodiments, the case is exemplified where the detection system is disposed in the oblique direction with respect to the sample. However, the detection system may be disposed in the direction perpendicular to the sample. In that case, the photoelectric conversion unit does not need to be inclined with respect to the optical axis, and is arranged on a surface conjugate to the sample.

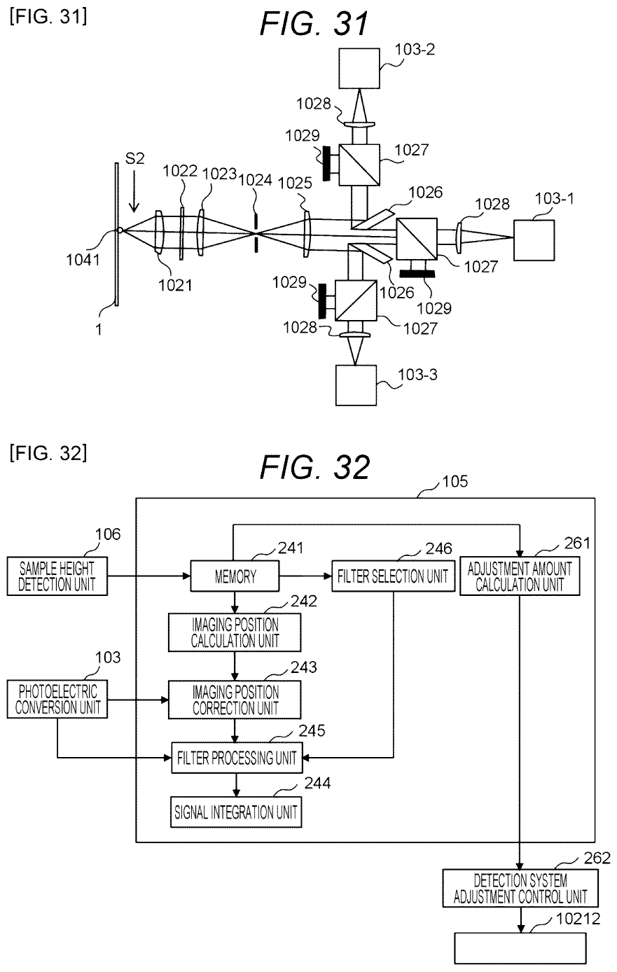

FIG. 31 is a configuration view of the detection unit according to this embodiment. In FIG. 31, the same constitutional elements as the constitutional elements illustrated in FIG. 12 are denoted by the same reference numerals, and the description of such constitutional elements will be omitted. Reference numeral 1029 indicates a beam diffuser 1029. The beam diffuser 1029 prevents unnecessary lights from becoming stray lights.

In FIG. 31, similarly to the configuration illustrated in FIG. 12, each detection point is branched for each detection vertex angle, and is detected. In the example illustrated in FIG. 31, the detected scattered lights are branched into three regions for each detection vertex angle and are detected by the photoelectric conversion units 103-2, 103-1, and 103-3, respectively. However, the number of branches can be arbitrarily determined, and the scattered lights can be branched into two or more regions. Also in this configuration, similarly to the configurations described in the first to third embodiments, an image shift or a change in the PSF occurs due to the displacement of the sample surface, and the image shift or the change in the PSF is different for each detection point vertex angle. In order to prevent lowering of sensitivity due to these phenomena, the correction is performed with the configurations illustrated in the first to third embodiments.

According to these embodiments, the photoelectric conversion unit 103 does not need to be arranged obliquely with respect to the optical axis and hence, a CCD or a TDI can also be used in place of a CMOS sensor.

### Fifth Embodiment

In this embodiment, the configuration will be described in which the second embodiment and the third embodiment are simultaneously carried out.

FIG. 32 is a functional block diagram of a signal processing unit according to this embodiment. The lowering of detection sensitivity can be suppressed by combining the decrease in an amount of difference in signal intensity due to the displacement of the sample height by the cross-correlation filter according to the third embodiment with the decrease in an amount of difference in signal intensity due to the displacement of the sample height by the adjustment of the optical element according to the second embodiment. With such a configuration, an adjustment amount of the optical element necessary for preventing lowering of desired sensitivity can be made smaller than the case where only the adjustment in the second embodiment is performed.

### Sixth Embodiment

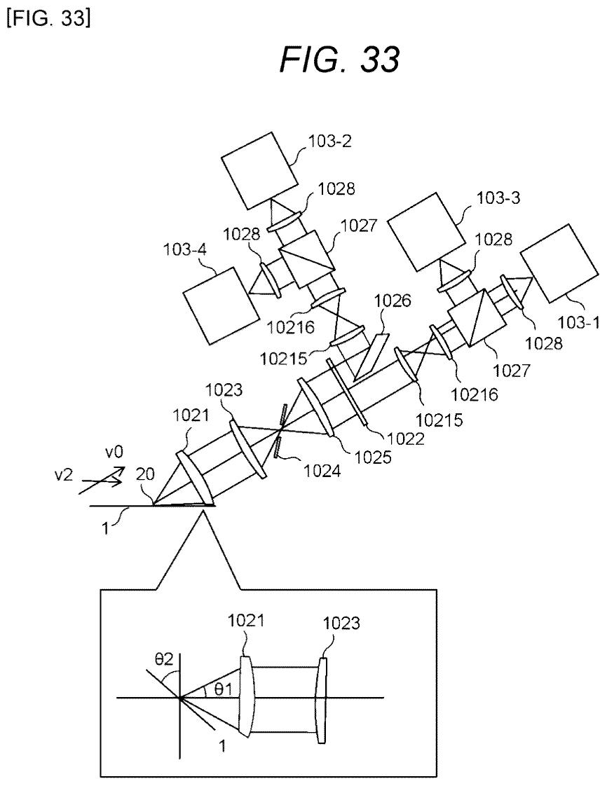

In the first embodiment, the configuration illustrated in FIG. 33 is also conceivable as an example of the detection unit illustrated in FIG. 12. That is, as illustrated in FIG. 33, one relay out of relays on the Fourier plane constituted of the imaging lens 10213 and the condenser lens 10214 in FIG. 12 is omitted, and the polarization control filter 1022 and the knife edge 1026 are arranged close to each other. With such a configuration, the length of the entire optical system can be shortened.

Although the embodiments have been described heretofore, the description of the embodiments is made in detail for facilitating the understanding the present invention. However, the present invention is not necessarily limited to the defect inspecting device that includes all constituent elements described above. Further, a part of the configuration of one embodiment can be replaced with the configuration of another embodiment, and the configuration of another embodiment can be added to the configuration of one embodiment. Further, with respect to parts of the configurations of the respective embodiments, the addition, the deletion and the replacement of other configurations can be made.

### REFERENCE SIGNS LIST

2 laser light source
5 beam expander
6 polarization control unit
7 illumination intensity distribution control unit
24 illumination intensity distribution monitor
10 defect inspecting device
53 control unit
54 display unit
55 input unit
101 illumination unit
102 detection unit
103 photoelectric conversion unit
104 stage
105 signal processing unit
106 sample height detection unit
102l objective lens
1022 polarization control filter
1023 imaging lens
1024 aperture
1025 condensing lens
1026 knife edge
1027 polarization beam splitter
1028 imaging lens
1029 beam diffuser
10210, 10211 cylindrical lens
10212 mechanism that adjusts position
10213 imaging lens
10214 condensing lens
10215 imaging lens
10216 condensing lens

1. A defect inspecting device comprising:
an illumination unit configured to irradiate a sample with light emitted from a light source;
a detection unit configured to detect scattered light generated from the sample;
a sample height detection unit configured to measure a variation amount of the sample in a direction perpendicular to a surface of the sample;
a photoelectric conversion unit that converts the scattered light detected by the detection unit into an electric signal; and
a signal processing unit configured to detect a defect of the sample by processing the electric signal converted by the photoelectric conversion unit,
wherein the detection unit includes a mechanism that adjusts a position after an aperture is branched corresponding to the variation amount of the surface of the sample acquired by the sample height detection unit, and a mechanism that detects scattered light generated from the sample by branching the aperture at a plurality of detection elevation angles in a separated manner, and
the signal processing unit includes a mechanism that corrects positions of a plurality of images formed by branching the aperture corresponding to the variation amount of the surface of the sample acquired by the sample height detection unit.

2. The defect inspecting device according to claim 1, wherein
the detection unit is disposed in an oblique direction with respect to the sample, and
the photoelectric conversion unit has a mechanism where a light receiving surface is arranged conjugate with respect to the sample and is inclined with respect to an optical axis.

3. The defect inspecting device according to claim 1, wherein the signal processing unit includes a filter processing mechanism different for each aperture, and includes a mechanism that suppresses lowering of sensitivity due to wafer surface deviation.

4. The defect inspecting device according to claim 3, wherein the filter processing mechanism includes a mechanism that corrects a correction residual of the detection unit corresponding to the variation amount of the surface of the sample acquired by the sample height detection unit.

5. The defect inspecting device according to claim 1, wherein the signal processing unit includes a mechanism that reduces a difference between signals at the time of defocusing and at the time of focusing.

6. The defect inspecting device according to claim 2, further comprising a mechanism that measures a vertical displacement of a sample surface.

7. A defect inspecting device comprising:
an illumination unit configured to irradiate a sample with light emitted from a light source;
a detection unit configured to detect a scattered light generated from the sample;
a sample height detection unit configured to measure a variation amount of the sample in a direction perpendicular to a surface of the sample;
a photoelectric conversion unit that converts the scattered light detected by the detection unit into an electric signal; and
a signal processing unit configured to detect a defect of the sample by processing the electric signal converted by the photoelectric conversion unit,
wherein the detection unit is disposed in an oblique direction with respect to a sample and includes a mechanism that detects scattered light generated from the sample by branching the aperture at a plurality of detection elevation angles in a separated manner, and
the photoelectric conversion unit is configured such that a light receiving surface is arranged conjugate with a sample and is inclined with respect to an optical axis.

8. The defect inspecting device according to claim 7, wherein
the detection unit includes a mechanism that adjusts a position after dividing an aperture according to the variation amount of the surface of the sample acquired by the sample height detection unit, and
the signal processing unit includes a mechanism that corrects positions of a plurality of images formed by dividing the aperture in accordance with the variation amount of the surface of the sample acquired by the sample height detection unit.

9. The defect inspecting device according to claim 8, wherein the signal processing unit includes a filter processing mechanism different for each aperture, and includes a mechanism that suppresses lowering of sensitivity due to wafer surface deviation.

10. The defect inspecting device according to claim 9, wherein the filter processing mechanism includes a mechanism that corrects a correction residual of the detection unit corresponding to the variation amount of the surface of the sample acquired by the sample height detection unit.

11. The defect inspecting device according to claim 8, wherein the signal processing unit includes a mechanism that reduces a difference between signals at the time of defocusing and at the time of focusing.

12. The defect inspecting device according to claim 7, further comprising a mechanism that measures a vertical displacement of a sample surface.

13. An optical system used in the detection unit of the defect inspecting device according to claim 7, the optical system comprising:
an objective lens that condenses the scattered light from the sample disposed on a first surface;
a branching optical member that is disposed on a second surface serving as a pupil with respect to the first surface by the objective lens and the relay lens, and branches the scattered light condensed by the objective lens into first scattered light and second scattered light; and
a first imaging optical system that condenses the first scattered light branched by the branching optical member and guides the first scattered light to a first photoelectric conversion unit; and
a second imaging optical system that condenses the second scattered light and guides the second scattered light to a second photoelectric conversion unit,
wherein an optical path of the first scattered light on the first surface side is inclined at a first angle with respect to a normal line of the first surface, and an optical path of the second scattered light on the first surface side is inclined at a second angle larger than the first angle with respect to the normal line of the first surface.

14. A defect inspecting method comprising:
irradiating a sample with light emitted from a light source;
measuring a variation amount of a sample in a direction perpendicular to a surface of the sample;
adjusting the position after dividing the aperture according to the measured variation amount of the surface of the sample, and separating and detecting scattered light generated from the sample at a plurality of detection elevation angles; and
converting the detected scattered light into an electric signal; and
correcting positions of a plurality of images of a plurality of scattered light detected corresponding to the measured variation amount of the surface of the sample with respect to the converted electric signal, thus detecting a defect of the sample.

15. A defect inspecting method comprising:
irradiating a sample with light emitted from a light source;
detecting scattered light generated from the sample by branching an aperture at a detection unit arranged in an oblique direction with respect to the sample and by separating the scattered light generated from the sample at a plurality of detection elevation angles; and
measuring a variation amount of a sample in a direction perpendicular to a surface of the sample;
converting the detected scattered light into an electric signal by a photoelectric conversion unit in which a light receiving surface is arranged in a conjugate manner with respect to a sample and is inclined with respect to an optical axis; and
processing the converted electric signal to detect a defect of the sample.
